(19) United States
(12) Patent Application Publication
(10) Pub. No.: US 2022/0110351 A1
(43) Pub. Date: Apr. 14, 2022

(54) POLYMETHOXYFLAVONES AND THEIR USE AS MOUTHFEEL ENHANCERS AND BITTERNESS MASKERS

(71) Applicant: Firmenich SA, Satigny (CH)

(72) Inventors: Wen-Juan XIANG, Shanghai (CN); Ronald H. SKIFF, Plainsboro, NJ (US); Ke HUANG, Shanghai (CN); Hui-Juan ZHANG, Shanghai (CN); Long CHEN, Shanghai (CN)

(73) Assignee: Firmenich SA, Satigny (CH)

(21) Appl. No.: 17/277,827

(22) PCT Filed: Oct. 7, 2019
(86) PCT No.: PCT/EP2019/077067

§ 371 Date: Mar. 19, 2021

(30) Foreign Application Priority Data
Oct. 9, 2018 (CN) PCT/CN2018/109438

(51) Int. Cl. A23L 27/00; A23L 2/56; A23L 2/60

(52) U.S. Cl. CPC A23L 27/88; A23L 27/86; A23V 2002/00; A23L 2/60; A23L 2/56

(57) ABSTRACT

The present disclosure provides compositions containing: 2-(3,4-dimethoxyphenyl)-5,6,7-trimethoxychromen-4-one (“sinensetin”); 3,5,6,7,8,3′,4′-heptamethoxyflavone (“heptamethoxyflavone” or “HMF”); 2-(3,4-dimethoxyphenyl)-5,6,7,8-tetramethoxy-chromen-4-one (“nobiletin”); 5,6,7,4′-tetramethoxyflavone (“tetra-O-methylscutellarein” or “TMS”); 3,5,6,7,3′,4′-hexamethoxyflavone (“hexamethoxyquercetogetin” or “HMQ”); 5,6,7,8-tetramethoxy-2-(4-methoxyphenyl)-4H-1-benzopyran-4-one (“tangeretin”); or any combinations thereof. The disclosure also provides uses of such compositions as mouthfeel enhancers or bitterness maskers of flavored articles, such as beverages.

### CROSS-REFERENCE TO RELATED APPLICATIONS

The present application claims priority to PCT Application No. PCT/CN2018/109438, filed Oct. 9, 2018, which is hereby incorporated by reference as though set forth herein in its entirety.

### TECHNICAL FIELD

The present disclosure provides compositions containing: 2-(3,4-dimethoxyphenyl)-5,6,7-trimethoxychromen-4-one (“sinensetin”); 3,5,6,7,8,3′,4′-heptamethoxyflavone (“heptamethoxyflavone” or “HMF”); 2-(3,4-dimethoxyphenyl)-5,6,7,8-tetramethoxy-chromen-4-one (“nobiletin”); 5,6,7,4′-tetramethoxyflavone (“tetra-O-methylscutellarein” or “TMS”); 3,5,6,7,3′,4′-hexamethoxyflavone (“hexamethoxyquercetogetin” or “HMQ”); 5,6,7,8-tetramethoxy-2-(4-methoxyphenyl)-4H-1-benzopyran-4-one (“tangeretin”); or any combinations thereof. The disclosure also provides uses of such compositions as mouthfeel enhancers or bitterness maskers of flavored articles, such as beverages.

### DESCRIPTION OF RELATED ART

The taste system provides sensory information about the chemical composition of the external world. Taste transduction is one of the more sophisticated forms of chemically triggered sensation in animals. Signaling of taste is found throughout the animal kingdom, from simple metazoans to the most complex of vertebrates. Mammals are believed to have five basic taste modalities: sweet, bitter, sour, salty, and umami.

Sweetness is the taste most commonly perceived when eating foods rich in sugars. Mammals generally perceive sweetness to be a pleasurable sensation, except in excess. Caloric sweeteners, such as sucrose and fructose, are the prototypical examples of sweet substances. Although a variety of no-calorie and low-calorie substitutes exist, these caloric sweeteners are still the predominant means by which comestible products induce the perception of sweetness upon consumption.

Metabolic disorders and related conditions, such as obesity, diabetes, and cardiovascular disease, are major public health concerns throughout the world. And their prevalence is increasing at alarming rates in almost every developed country. Caloric sweeteners are a key contributor to this trend, as they are included in various packaged food and beverage products to make them more palatable to consumers. In many cases, no-calorie or low-calorie substitutes can be used in foods and beverages in place of sucrose or fructose. Even so, these compounds impart sweetness differently from caloric sweeteners, and a number of consumers fail to view them as suitable alternatives. Moreover, such compounds may be difficult to incorporate into certain products. In some instances, they may be used as partial replacements for caloric sweeteners, but their mere presence can cause many consumers to perceive an unpleasant bitterness or an undesirable mouthfeel. Therefore, lower-calorie sweeteners still face certain challenges to their adoption.

Certain compounds can be used to mask bitterness, improve mouthfeel, or both. But these compounds are often not completely effective. Or, in some cases, they are not natural compounds. Therefore, including them in food or beverage products prevents such products from having clean labeling, which is often desired by consumers and providers. Hence, there is a continuing need to discover compounds, especially natural compounds, that can mast bitterness and/or improve mouthfeel of food and beverage products, especially when used in combination with low-calorie or no-calorie sugar replacements.

### SUMMARY

The present disclosure relates to the discovery that certain polymethoxyflavones have beneficial properties as flavor modifiers, particularly masking bitterness and/or enhancing mouthfeel.

In a first aspect, the disclosure provides uses of polymethoxyflavones to modify a flavor of a consumable product. In some embodiments, modifying the flavor comprises enhancing a mouthfeel, reducing bitterness, or a combination thereof. In some embodiments, the polymethoxyflavones are present in the consumable product at a concentration ranging from 0.5 ppm to 50 ppm, or from 0.5 ppm to 20 ppm, or from 1 ppm to 5 ppm. In some embodiments, the polymethoxyflavones are: sinensetin, heptamethoxyflavone, nobiletin, tetra-O-methylscutellarein, hexamethoxyquercetogetin, tangeretin, or any combination thereof. In some embodiments, the consumable product comprises a sweetener, such as a low-caloric sweetener. In some embodiments, the consumable product is a beverage product, such as a low-caloric beverage, a greened juice, or a bitter beverage (e.g., tea or coffee).

In a second aspect, the disclosure provides a method of modifying a flavor of a consumable product, the method comprising: introducing polymethoxyflavones to a consumable product. In some embodiments, the method of modifying the flavor of a consumable product comprises enhancing a mouthfeel of a consumable product, reducing bitterness of a consumable product, or a combination thereof. In some embodiments, the polymethoxyflavones are present in the consumable product at a concentration ranging from 0.5 ppm to 50 ppm, or from 0.5 ppm to 20 ppm, or from 1 ppm to 5 ppm. In some embodiments, the polymethoxyflavones are: sinensetin, heptamethoxyflavone, nobiletin, tetra-O-methylscutellarein, hexamethoxyquercetogetin, tangeretin, or any combination thereof. In some embodiments, the consumable product comprises a sweetener, such as a low-caloric sweetener. In some embodiments, the consumable product is a beverage product, such as a low-caloric beverage, a greened juice, or a bitter beverage (e.g., tea or coffee).

In a third aspect, the disclosure provides a consumable product, wherein the consumable product comprises a polymethoxyflavone. In some embodiments, the consumable product is a non-naturally-occurring product. In some embodiments, the polymethoxyflavones are present in the consumable product at a concentration ranging from 0.5 ppm to 50 ppm, or from 0.5 ppm to 20 ppm, or from 1 ppm to 5 ppm. In some embodiments, the polymethoxyflavones are: sinensetin, heptamethoxyflavone, nobiletin, tetra-O-methylscutellarein, hexamethoxyquercetogetin, tangeretin, or any combination thereof. In some embodiments, the polymethoxyflavones are present in the consumable product to reduce the bitterness of the consumable product, enhance the mouthfeel of the consumable product, or a combination thereof. In some embodiments, the consumable product comprises a sweetener, such as a low-caloric sweetener. In some embodiments, the consumable product is a beverage product, such as a low-caloric beverage, a greened juice, or a bitter beverage (e.g., tea or coffee).

Further aspects and embodiments are set forth in the foregoing Detailed Description and the drawings.

### BRIEF DESCRIPTION OF THE FIGURES

The following drawings are provided for purposes of illustrating various embodiments of the compositions and methods disclosed herein. The drawings are provided for illustrative purposes only, and are not intended to describe any preferred compositions or preferred methods, or to serve as a source of any limitations on the scope of the claimed inventions.

FIG. 1 shows the effect of the addition of an extract containing 2 ppm of a composition according to certain embodiments set forth herein on the perception of mouthfeel of a lemon-lime carbonated soft drink.

### DETAILED DESCRIPTION

In the following description, reference is made to specific embodiments which may be practiced, which is shown by way of illustration. These embodiments are described in detail to enable those skilled in the art to practice the invention described herein, and it is to be understood that other embodiments may be used and that logical changes may be made without departing from the scope of the aspects presented herein. The following description of example embodiments is, therefore, not to be taken in a limited sense, and the scope of the various aspects presented herein is defined by the appended claims.

Consumable products, such as diet or low-calorie beverages often have a lower, or lack a perceived mouthfeel, due, in part, to the decreased presence or absence of traditional caloric sweeteners. But when polymethoxyflavones are added to such a consumable product, they can have a tendency to enhance the mouthfeel, such that the resulting mouthfeel is comparable to that of a consumable product containing traditional caloric sweeteners.

Further, certain consumable products, such as greened juices, products containing natural sweeteners (e.g., stevia extracts, luo han guo extracts, sucrose, HFCS) or high intensity sweeteners frequently have unpleasant off-flavors, such as bitterness. But when polymethoxyflavones are added to such a consumable product, they also tend to reduce the unpleasant off-flavors, such as bitterness, imparted by low-calorie or no-calorie sygar substitutes.

As used herein, the term “enhance” means to have an effect on a particular flavor sensation in consumables or other products placed in the oral cavity which is found more pronounced (stronger, enhanced) in its taste intensity and/or which is found to have an earlier onset of the flavor sensation.

As used herein, the term “greened juice” refers to juice extracted from a citrus fruit that has citrus greening disease, HLB, citrus vein phloem degeneration (CVPD), yellow shoot disease, leaf mottle yellows, or citrus dieback. Citrus greening disease is caused by a vector-transmitted pathogen, the causative agents are motile bacteria, Candidatus Liberibacter spp. The disease is vectored and transmitted by the Asian citrus psyllid, Diaphorina citri, and the African citrus psyllid, Trioza erytreae. Citrus greening disease has also been shown to be graft-transmissible.

As used herein, the term “high intensity sweetener” means any sweetener, which may in raw, extracted, purified, or any other from, singularly or in combination thereof have a sweetness potency greater than sucrose (common table sugar) yet have comparatively less calories. As used herein, the term “sweetener(s)” includes all artificial and natural sweeteners, sugar alcohols (or polyols) and sugar sweeteners (or carbohydrates).

As shown in the Examples below, the present disclosure sets forth the surprising and unexpected discovery that polymethoxyflavones are useful as a bitterness maskers and/or a mouthfeel enhancers, such as when used at low concentrations in beverage products.

Accordingly, one aspect presented herein provides a composition comprising polymethoxyflavones, wherein the composition, when added to a consumable product at a concentration from 0.5 to 20 ppm, enhances the mouthfeel perceived by a subject, compared to the mouthfeel of a consumable product lacking the composition that is perceived by the subject. In some embodiments, the inclusion of the polymethoxyflavones in the consumable product reduces the bitterness perceived by a subject, compared to the bitterness of a consumable product lacking the polymethoxyflavones that is perceived by the subject.

### Polymethoxyflavone Compositions

In one or more aspects, the disclosure provides a composition, wherein the composition comprises a polymethoxyflavone. In some embodiments, the composition is a consumable product, such as a food or beverage product. In some embodiments, the composition or consumable product is a non-naturally-occurring product.

Any suitable polymethoxyflavones can be used. In some embodiments, the polymethoxyflavones comprise sinensetin, quercetagetin, nobiletin, tetra-O-methylscutellarein, hexamethoxyquercetogetin, tangeretin, or any combinations thereof.

As used herein, the term “sinensetin” refers to 2-(3,4-dimethoxyphenyl)-5,6,7-trimethoxychromen-4-one, or the compound having the structure:

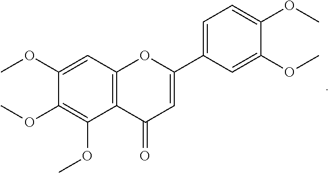

As used herein, the term “heptamethoxyflavone” refers to the compound 3,5,6,7,8,3′,4′-heptamethoxyflavone, or the compound having the structure:

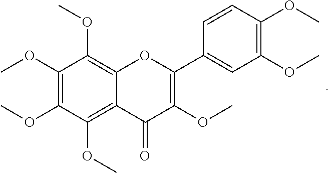

As used herein, the term “nobiletin” refers to the compound 2-(3,4-dimethoxyphenyl)-5,6,7,8-tetramethoxychromen-4-one, or the compound having the structure:

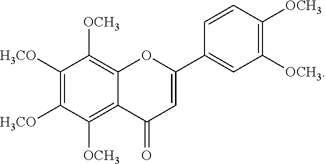 [SMILES: COc1ccc(-c2cc(=O)c3c(OC)c(OC)c(OC)c(OC)c3o2)cc1OC]

As used herein, the term “tetra-O-methylscutellarein” or “TMS” refers to the compound 5,6,7,4′-tetramethoxyflavone, or the compound having the structure:

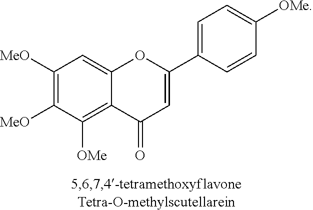 [SMILES: COc1ccc(-c2cc(=O)c3c(OC)c(OC)c(OC)cc3o2)cc1]

As used herein, the term “hexamethoxyquercetogetin” or “HMQ” refers to the compound 3,5,6,7,3′,4′-hexamethoxyflavone, or the compound having the structure:

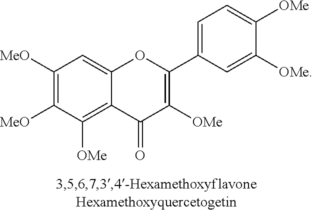 [SMILES: COc1ccc(-c2oc3cc(OC)c(OC)c(OC)c3c(=O)c2OC)cc1OC]

As used herein, the term “tangeretin” or “HMQ” refers to the compound 5,6,7,8-tetramethoxy-2-(4-methoxyphenyl)-4H-1-benzopyran-4-one, or the compound having the structure:

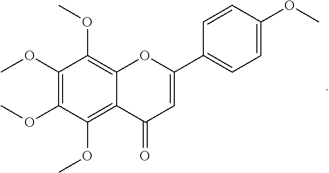

The polymethoxyflavones can be obtained from any suitable source. In some embodiments, they are isolated from biomass. In some other embodiments, they are chemically synthesized, whether by traditional chemical means or by enzymatic processes. Examples of biomass include, but are not limited to fruit, leaves, stems, bark, or roots of plants.

For example, polymethoxyflavones can be obtained from a variety of natural sources, such as from the peel and/or pulp of plants from the Citrus genus. The particular polymethoxyflavones, and their concentration may vary, depending on the particular species of citrus plant. For example, polymethoxyflavones are found in the peel of some citrus species, such as sweet orange (Citrus sinensis), mandarin (Citrus reticulate Blanco) and tangerine (Citrus tangerina). Suitable biomass includes, but is not limited to: sweet orange (C. sinensis), mandarin (Citrus reticulata Blanco), tangerine (Citrus tangerina), king orange (Citrus nobilis), Seville orange (Citrus aurantium), round kumquat (Fortunella japonica), ponkan (Citrus deliciosa), unshiu (Citrus unshiu), clementine (Citrus celementina), bitter orange (Citrus aurantium), grapefruit (Citrus paradisi), bergamot (Citrus bergamia), citrus hybrid such as ortanique, a hybrid between tangerine (Citrus reticulata) and sweet orange (Citrus sinensis), Eupatorium coelestinum, Eupatorium leucolepis, Hedyotis corymbosa, Croton caudatus, Marrubium velutinum, Marrubium cylleneum, Conocliniopsis prasiifolia, Bauhinia guianensis, Chromolaena odorata, Praxelis clematidea, Orthosiphon stamineus, Orthosiphon stamineus, or Geoffroea decorticans.

In some embodiments, the composition comprising polymethoxyflavones is obtained from biomass by a process described in PCT Publication No. WO 2012/107203.

In some embodiments, the composition comprising polymethoxyflavones is purified from a non-volatile residue from orange oil distillation. In some embodiments, the composition comprising polymethoxyflavones is purified from an orange oil by first extracting orange oil in an aqueous organic solvent, and then fractionating the extract via chromatography to obtain the composition comprising polymethoxyflavones.

In some embodiments, the composition comprising polymethoxyflavones is synthesized according to the methods described in PCT Publication No. WO 2007/083263.

Alternatively, in some embodiments, the composition comprising polymethoxyflavones is synthesized according to the methods described in PCT Publication No. WO 2011/130705.

In some embodiments, the composition comprising polymethoxyflavones is obtained according to the methods described in PCT Publication No. WO 2012/107203.

In some embodiments, the composition comprising polymethoxyflavones is obtained according to the methods described in Japanese Patent Application Publication No. 2009051738.

In some embodiments, the composition comprising polymethoxyflavones is obtained according to the methods described in Journal of Agricultural and Food Chemistry, vol. 45(2), pp. 364-368 (1997).

In some embodiments, the composition comprising polymethoxyflavones is obtained according to the methods described in U.S. Patent Application Publication No. 2015/0125557.

In some embodiments, the composition comprising polymethoxyflavones is obtained according to the methods described in Essenze, Derivati Agrumari (1993), 63(4), 395-406.

In some embodiments, the composition comprising polymethoxyflavones is obtained according to the methods described in Molecules 2015, 20, 20079-20106.

In some aspects, the composition comprising polymethoxyflavones is obtained according to the methods described in Journal of Agricultural and Food Chemistry (2012), 60(17), 4336-4341.

In some embodiments, the composition comprising polymethoxyflavones is obtained according to the methods described in Food Chemistry (2009), 119(2), 567-572.

In some embodiments, the composition comprising polymethoxyflavones is obtained according to the methods described in Technologies in the Biomedical and Life Sciences (2007), 846(1-2), 291-297.

In some embodiments, the composition comprising polymethoxyflavones is obtained according to the methods described in Journal of Agricultural and Food Chemistry (2006), 54(12), 4176-4185.

In some embodiments, the composition comprising polymethoxyflavones is obtained according to the methods described in Biomedical Chromatography (2006), 20(1), 133-138.

In some embodiments, the composition, when added to a consumable product at a concentration from 0.5 to 20 ppm, enhances the mouthfeel of the consumable product. Alternatively, in some embodiments, the composition, when added to a consumable product at a concentration from 0.5 to 19 ppm, enhances the mouthfeel of the consumable product. Alternatively, in some embodiments, the composition, when added to a consumable product at a concentration from 0.5 to 18 ppm, enhances the mouthfeel of the consumable product. Alternatively, in some embodiments, the composition, when added to a consumable product at a concentration from 0.5 to 17 ppm, enhances the mouthfeel of the consumable product. Alternatively, in some embodiments, the composition, when added to a consumable product at a concentration from 0.5 to 16 ppm, enhances the mouthfeel of the consumable product. Alternatively, in some embodiments, the composition, when added to a consumable product at a concentration from 0.5 to 15 ppm, enhances the mouthfeel of the consumable product. Alternatively, in some embodiments, the composition, when added to a consumable product at a concentration from 0.5 to 14 ppm, enhances the mouthfeel of the consumable product. Alternatively, in some embodiments, the composition, when added to a consumable product at a concentration from 0.5 to 13 ppm, enhances the mouthfeel of the consumable product. Alternatively, in some embodiments, the composition, when added to a consumable product at a concentration from 0.5 to 12 ppm, enhances the mouthfeel of the consumable product. Alternatively, in some embodiments, the composition, when added to a consumable product at a concentration from 0.5 to 11 ppm, enhances the mouthfeel of the consumable product. Alternatively, in some embodiments, the composition, when added to a consumable product at a concentration from 0.5 to 10 ppm, enhances the mouthfeel of the consumable product. Alternatively, in some embodiments, the composition, when added to a consumable product at a concentration from 0.5 to 9 ppm, enhances the mouthfeel of the consumable product. Alternatively, in some embodiments, the composition, when added to a consumable product at a concentration from 0.5 to 8 ppm, enhances the mouthfeel of the consumable product. Alternatively, in some embodiments, the composition, when added to a consumable product at a concentration from 0.5 to 7 ppm, enhances the mouthfeel of the consumable product. Alternatively, in some embodiments, the composition, when added to a consumable product at a concentration from 0.5 to 6 ppm, enhances the mouthfeel of the consumable product. Alternatively, in some embodiments, the composition, when added to a consumable product at a concentration from 0.5 to 5 ppm, enhances the mouthfeel of the consumable product. Alternatively, in some embodiments, the composition, when added to a consumable product at a concentration from 0.5 to 4 ppm, enhances the mouthfeel of the consumable product. Alternatively, in some embodiments, the composition, when added to a consumable product at a concentration from 0.5 to 3 ppm, enhances the mouthfeel of the consumable product. Alternatively, in some embodiments, the composition, when added to a consumable product at a concentration from 0.5 to 2 ppm, enhances the mouthfeel of the consumable product. Alternatively, in some embodiments, the composition, when added to a consumable product at a concentration from 0.5 to 1 ppm, enhances the mouthfeel of the consumable product.

Alternatively, in some embodiments, the composition, when added to a consumable product at a concentration from 0.5 to 20 ppm, enhances the mouthfeel of the consumable product. Alternatively, in some embodiments, the composition, when added to a consumable product at a concentration from 1 to 20 ppm, enhances the mouthfeel of the consumable product. Alternatively, in some embodiments, the composition, when added to a consumable product at a concentration from 2 to 20 ppm, enhances the mouthfeel of the consumable product. Alternatively, in some embodiments, the composition, when added to a consumable product at a concentration from 3 to 20 ppm, enhances the mouthfeel of the consumable product. Alternatively, in some embodiments, the composition, when added to a consumable product at a concentration from 4 to 20 ppm, enhances the mouthfeel of the consumable product. Alternatively, in some embodiments, the composition, when added to a consumable product at a concentration from 5 to 20 ppm, enhances the mouthfeel of the consumable product. Alternatively, in some embodiments, the composition, when added to a consumable product at a concentration from 6 to 20 ppm, enhances the mouthfeel of the consumable product. Alternatively, in some embodiments, the composition, when added to a consumable product at a concentration from 7 to 20 ppm, enhances the mouthfeel of the consumable product. Alternatively, in some embodiments, the composition, when added to a consumable product at a concentration from 8 to 20 ppm, enhances the mouthfeel of the consumable product. Alternatively, in some embodiments, the composition, when added to a consumable product at a concentration from 9 to 20 ppm, enhances the mouthfeel of the consumable product. Alternatively, in some embodiments, the composition, when added to a consumable product at a concentration from 10 to 20 ppm, enhances the mouthfeel of the consumable product. Alternatively, in some embodiments, the composition, when added to a consumable product at a concentration from 11 to 20 ppm, enhances the mouthfeel of the consumable product. Alternatively, in some embodiments, the composition, when added to a consumable product at a concentration from 12 to 20 ppm, enhances the mouthfeel of the consumable product. Alternatively, in some embodiments, the composition, when added to a consumable product at a concentration from 13 to 20 ppm, enhances the mouthfeel of the consumable product. Alternatively, in some embodiments, the composition, when added to a consumable product at a concentration from 14 to 20 ppm, enhances the mouthfeel of the consumable product. Alternatively, in some embodiments, the composition, when added to a consumable product at a concentration from 15 to 20 ppm, enhances the mouthfeel of the consumable product. Alternatively, in some embodiments, the composition, when added to a consumable product at a concentration from 16 to 20 ppm, enhances the mouthfeel of the consumable product. Alternatively, in some embodiments, the composition, when added to a consumable product at a concentration from 17 to 20 ppm, enhances the mouthfeel of the consumable product. Alternatively, in some embodiments, the composition, when added to a consumable product at a concentration from 18 to 20 ppm, enhances the mouthfeel of the consumable product. Alternatively, in some embodiments, the composition, when added to a consumable product at a concentration from 19 to 20 ppm, enhances the mouthfeel of the consumable product.

In some embodiments, the composition, when added to a consumable product at a concentration of 0.5, or 1, or 2, or 3, or 4, or 5, or 6, or 7, or 8, or 9, or 10, or 11, or 12, or 13, or 14, or 15, or 16, or 17, or 18, or 19, or 20 ppm, enhances the mouthfeel of the consumable product.

In some embodiments, the composition, when added to a consumable product at a concentration from 0.5 to 20 ppm, reduces the bitterness of the consumable product. Alternatively, in some embodiments, the composition, when added to a consumable product at a concentration from 0.5 to 19 ppm, reduces the bitterness of the consumable product. Alternatively, in some embodiments, the composition, when added to a consumable product at a concentration from 0.5 to 18 ppm, reduces the bitterness of the consumable product. Alternatively, in some embodiments, the composition, when added to a consumable product at a concentration from 0.5 to 17 ppm, reduces the bitterness of the consumable product. Alternatively, in some embodiments, the composition, when added to a consumable product at a concentration from 0.5 to 16 ppm, reduces the bitterness of the consumable product. Alternatively, in some embodiments, the composition, when added to a consumable product at a concentration from 0.5 to 15 ppm, reduces the bitterness of the consumable product. Alternatively, in some embodiments, the composition, when added to a consumable product at a concentration from 0.5 to 14 ppm, reduces the bitterness of the consumable product. Alternatively, in some embodiments, the composition, when added to a consumable product at a concentration from 0.5 to 13 ppm, reduces the bitterness of the consumable product. Alternatively, in some embodiments, the composition, when added to a consumable product at a concentration from 0.5 to 12 ppm, reduces the bitterness of the consumable product. Alternatively, in some embodiments, the composition, when added to a consumable product at a concentration from 0.5 to 11 ppm, reduces the bitterness of the consumable product. Alternatively, in some embodiments, the composition, when added to a consumable product at a concentration from 0.5 to 10 ppm, reduces the bitterness of the consumable product. Alternatively, in some embodiments, the composition, when added to a consumable product at a concentration from 0.5 to 9 ppm, reduces the bitterness of the consumable product. Alternatively, in some embodiments, the composition, when added to a consumable product at a concentration from 0.5 to 8 ppm, reduces the bitterness of the consumable product. Alternatively, in some embodiments, the composition, when added to a consumable product at a concentration from 0.5 to 7 ppm, reduces the bitterness of the consumable product. Alternatively, in some embodiments, the composition, when added to a consumable product at a concentration from 0.5 to 6 ppm, reduces the bitterness of the consumable product. Alternatively, in some embodiments, the composition, when added to a consumable product at a concentration from 0.5 to 5 ppm, reduces the bitterness of the consumable product. Alternatively, in some embodiments, the composition, when added to a consumable product at a concentration from 0.5 to 4 ppm, reduces the bitterness of the consumable product. Alternatively, in some embodiments, the composition, when added to a consumable product at a concentration from 0.5 to 3 ppm, reduces the bitterness of the consumable product. Alternatively, in some embodiments, the composition, when added to a consumable product at a concentration from 0.5 to 2 ppm, reduces the bitterness of the consumable product. Alternatively, in some embodiments, the composition, when added to a consumable product at a concentration from 0.5 to 1 ppm, reduces the bitterness of the consumable product.

Alternatively, in some embodiments, the composition, when added to a consumable product at a concentration from 0.5 to 20 ppm, reduces the bitterness of the consumable product. Alternatively, in some embodiments, the composition, when added to a consumable product at a concentration from 1 to 20 ppm, reduces the bitterness of the consumable product. Alternatively, in some embodiments, the composition, when added to a consumable product at a concentration from 2 to 20 ppm, reduces the bitterness of the consumable product. Alternatively, in some embodiments, the composition, when added to a consumable product at a concentration from 3 to 20 ppm, reduces the bitterness of the consumable product. Alternatively, in some embodiments, the composition, when added to a consumable product at a concentration from 4 to 20 ppm, reduces the bitterness of the consumable product. Alternatively, in some embodiments, the composition, when added to a consumable product at a concentration from 5 to 20 ppm, reduces the bitterness of the consumable product. Alternatively, in some embodiments, the composition, when added to a consumable product at a concentration from 6 to 20 ppm, reduces the bitterness of the consumable product. Alternatively, in some embodiments, the composition, when added to a consumable product at a concentration from 7 to 20 ppm, reduces the bitterness of the consumable product. Alternatively, in some embodiments, the composition, when added to a consumable product at a concentration from 8 to 20 ppm, reduces the bitterness of the consumable product. Alternatively, in some embodiments, the composition, when added to a consumable product at a concentration from 9 to 20 ppm, reduces the bitterness of the consumable product. Alternatively, in some embodiments, the composition, when added to a consumable product at a concentration from 10 to 20 ppm, reduces the bitterness of the consumable product. Alternatively, in some embodiments, the composition, when added to a consumable product at a concentration from 11 to 20 ppm, reduces the bitterness of the consumable product. Alternatively, in some embodiments, the composition, when added to a consumable product at a concentration from 12 to 20 ppm, reduces the bitterness of the consumable product. Alternatively, in some embodiments, the composition, when added to a consumable product at a concentration from 13 to 20 ppm, reduces the bitterness of the consumable product. Alternatively, in some embodiments, the composition, when added to a consumable product at a concentration from 14 to 20 ppm, reduces the bitterness of the consumable product. Alternatively, in some embodiments, the composition, when added to a consumable product at a concentration from 15 to 20 ppm, reduces the bitterness of the consumable product. Alternatively, in some embodiments, the composition, when added to a consumable product at a concentration from 16 to 20 ppm, reduces the bitterness of the consumable product. Alternatively, in some embodiments, the composition, when added to a consumable product at a concentration from 17 to 20 ppm, reduces the bitterness of the consumable product. Alternatively, in some embodiments, the composition, when added to a consumable product at a concentration from 18 to 20 ppm, reduces the bitterness of the consumable product. Alternatively, in some embodiments, the composition, when added to a consumable product at a concentration from 19 to 20 ppm, reduces the bitterness of the consumable product.

In some embodiments, the composition, when added to a consumable product at a concentration of 0.5, or 1, or 2, or 3, or 4, or 5, or 6, or 7, or 8, or 9, or 10, or 11, or 12, or 13, or 14, or 15, or 16, or 17, or 18, or 19, or 20 ppm, reduces the bitterness of the consumable product.

The taste and/or mouthfeel of a sample of a composition according to several embodiments presented herein, with regard to sweetness and/or sweetness enhancing properties, may be assessed in vivo by using a panel of trained sensory evaluators experienced in the sweet taste estimation procedure, e.g. in the sensory assay described e.g. in Example 1, using a suitable test suitable composition.

The composition may comprise the polymethoxyflavones in a purity of greater than about 60% by weight, e.g., greater than about 70% by weight, greater than about 80% by weight, greater than about 90% by weight, greater than about 98% by weight, or greater than about 99% by weight.

In some aspects, the consumable product comprises at least one sweetener. In some embodiments, the sweetener is an artificial sweetener, or, alternatively, a natural sweetener. In some embodiments, the sweetener is selected from the group consisting of: abiziasaponin, abrusosides, in particular abrusoside A, abrusoside B, abrusoside C, abrusoside D, acesulfame potassium, advantame, albiziasaponin, alitame, aspartame, superaspartame, bayunosides, in particular bayunoside 1, bayunoside 2, brazzein, bryoside, bryonoside, bryonodulcoside, carnosifloside, carrelame, curculin, cyanin, chlorogenic acid, cyclamates and its salts, cyclocaryoside I, dihydroquercetin-3-acetate, dihydroflavenol, dulcoside, gaudichaudioside, glycyrrhizin, glycyrrhetin acid, gypenoside, hematoxylin, isomogrosides, in particular iso-mogroside V, lugduname, magap, mabinlins, micraculin, mogrosides (lo han guo), in particular mogroside IV and mogroside V, monatin and its derivatives, monellin, mukurozioside, naringin dihydrochalcone (NarDHC), neohesperidin dihydrochalcone (NHDC), neotame, osladin, pentadin, periandrin I-V, perillartine, D-phenylalanine, phlomisosides, in particular phlomisoside 1, phlomisoside 2, phlomisoside 3, phlomisoside 4, phloridzin, phyllodulcin, polpodiosides, polypodoside A, pterocaryosides, rebaudiosides, in particular rebaudioside A, rebaudioside B, rebaudioside C, rebaudioside D, rebaudioside E, rebaudioside F, rebaudioside G, rebaudioside H, rebaudioside M, rubusosides, saccharin and its salts and derivatives, scandenoside, selligueanin A, siamenosides, in particular siamenoside I, stevia, steviolbioside, stevioside and other steviol glycosides, strogines, in particular strogin 1, strogin 2, strogin 4, suavioside A, suavioside B, suavioside G, suavioside H, suavioside I, suavioside J, sucralose, sucronate, sucrooctate, talin, telosmoside A15, thaumatin, in particular thaumatin I and II, trans-anethol, trans-cinnamaldehyde, trilobatin, D-tryptophane, erythritol, galactitol, hydrogenated starch syrups including maltitol and sorbitol syrups, inositols, isomalt, lactitol, maltitol, mannitol, xylitol, arabinose, dextrin, dextrose, fructose, high fructose corn syrup, fructooligosaccharides, fructooligosaccharide syrups, galactose, galactooligosaccharides, glucose, glucose and (hydrogenated) starch syrups/hydrolysates, isomaltulose, lactose, hydrolysed lactose, maltose, mannose, rhamnose, ribose, sucrose, tagatose, trehalose, xylose, and any combinations thereof.

In some embodiments, the sweetener is selected from the sweeteners disclosed in PCT Publication No. WO 2012/107203.

Alternatively, in some embodiments, the sweetener is selected from the compounds disclosed in PCT Publication No. WO 2011/130705.

Alternatively, in some embodiments, the sweetener is selected from the compounds disclosed in European Patent No. EP 0 605 261 B1.

Alternatively, in some embodiments, the sweetener is a polymethoxyflavone disclosed in PCT Publication No. WO 2012/107203.

Alternatively, in some embodiments, the sweetener is a polymethoxyflavone disclosed in PCT Publication No. WO 2011/130705.

Alternatively, in some embodiments, the sweetener may be a polymethoxyflavone disclosed in European Patent No. 0 605 261.

In some embodiments, the composition further comprises one or more sweetness enhancers, e.g., at least two or at least three. Any suitable sweetness enhancer can be used. In one embodiment, the at least one sweetness enhancer is selected from the group consisting of terpenes (such as sesquiterpenes, diterpenes, and triterpenes); flavonoids; amino acids; proteins; polyols; other known natural sweeteners (such as cinnamaldehydes, selligueains and hematoxylins); secodammarane glycosides; and analogues and combinations thereof. Non-limiting examples of sweetness enhancers include steviol glycoside such as stevioside, steviolbioside, rebaudioside A, rebaudioside B, rebaudioside C, rebaudioside D, rebaudioside E, rebaudioside F, dulcoside A, rubusoside; hernandulcin; pine rosin diterpenoid; mukurozioside; baiyunosdie; phlomisoside, such as phlomisoside I and phlomisodie II; glycyrrhizic acid; periandrins, such as periandrin I, periandrin II, periandrin III, and periandrin IV; osladin; polypodosides, such as polypodoside A and polypodoside B; mogrosides, such as mogroside IV and mogroside V; abrusoside A and abrusosdie B; cyclocariosdies, such as cyclocarioside A and cyclocarioside B; pterocaryoside A and pterocaryoside B; flavonoids, such as phyllodulcin, phloridzin, neoastilbin, and dihydroquercetin acetate; amino acids, such as glycine and monatin; proteins, such as thaumatins (thaumatin I, thaumatin II, thaumatin iii, and thaumatin IV), monellin, mabinlins (mabinlin I and mabinlin II), brazzein, miraculin, and curculin; polyols such as erythritol; cinnamaldehyde; selligueains, such as selligueain A and selligueain B; hematoxylin; and mixtures thereof. Additional exemplary sweetness enhancers include pine rosin diterpenoids; phloridizin; neoastilbin; dihydroquercetin acetate; glycine; erythritol; cinnamaldehyde; selligueain A; selligueain B; hematoxylin; rebaudioside A; rebaudioside B; rebaudioside C; rebaudioside D; rebaudioside E; dulcoside A; steviolbioside; rubusoside; stevia; stevioside; steviol 13-O-β-D-glycoside; mogroside V; Luo Han Guo; siamenoside; siamenoside I; monatin and salts thereof (monatin SS, RR, RS, SR); curculin; glycyrrhizic acid and its salts; thaumatin I; thaumatin II; thaumatin III; thaumatin IV; monellin; mabinlin I; mabinlin II; brazzein; hernandulcin; phyllodulcin; glycyphyllin; phloridzin; trilobatin; baiyunoside; osladin; polypodoside A; polypodoside B; pterocaryoside A; pterocaryoside B; mukurozioside; mukurozioside lib; phlomisoside I; phlomisoside II; periandrin I; periandrin II; periandrin III; periandrin VI; periandrin V; cyclocarioside A; cyclocarioside B; suavioside A; suavioside B; suavioside G; suavioside H; suavioside I; suavioside J; labdane glycosides; baiyunoside; gaudichaudioside A; mogroside IV; iso-mogroside; bryodulcoside; bryobioside; bryoside; bryonoside; carnosifloside V; carnosifioside VI; scandenoside R6; 11-oxomogroside V; abrusoside A; abrusoside B; abrusoside C; abrusoside D; abrusoside E; gypenoside XX; glycyrrhizin; apioglycyrrhizin; araboglycyrrhizin; pentadin; perillaldehyde; rebaudioside F; steviol; 13-[(2-O-(3-O-α-D-glucopyranosyl)-β-D-glucopyranosyl-3-O-β-D-glucopyranosyl-β-D-glucopyranosyl)oxy]kaur-16-en-18-oic acid β-D-glucopyranosyl ester; 13-[(2-O-β-D-glucopyranosyl-3-O-(4-O-α-D-glucopyranosyl)-β-D-glucopyranosyl-β-D-glucopyranosyl)oxy] kaur-16-en-18-oic acid β-D-glucopyranosyl ester; 13-[(3-O-β-D-glucopyranosyl-β-D-glucopyranosyl)oxy]kaur-16-en-18-oic acid β-D-glucopyranosyl ester; 13-hydroxy-kaur-16-en-18-oic acid β-D-glucopyranosyl ester; 13-methyl-16-oxo-17-norkauran-18-oic acid β-D-glucopyranosyl ester; 13-[(2-O-β-D-glucopyranosyl-3-O-β-D-glucopyranosyl-β-D-glucopyranosyl)oxy] kaur-15-en-18-oic acid β-D-glucopyranosyl ester; 13-[(2-O-β-D-glucopyranosyl-3-O-β-D-glucopyranosyl-β-D-glucopyranosyl)oxy] kaur-15-en-18-oic acid; 13-[(2-O-β-D-glucopyranosyl-3-O-β-D-glucopyranosyl]-3-D-glucopyranosyl)oxy]-17-hydroxy-kaur-15-en-18-oic acid β-D-glucopyranosyl ester; 13-[(2-O-β-D-glucopyranosyl-3-O-β-D-glucopyranosyl-β-D-glucopyranosyl)oxy]-16-hydroxy kauran-18-oic acid β-D-glucopyranosyl ester; 13-[(2-O-β-D-glucopyranosyl-3-O-β-D-glucopyranosyl-β-D-glucopyranosyl)oxy]-16-hydroxy kauran-18-oic acid; isosteviol; mogroside IA; mogroside IE; mogroside 11-A; mogroside 11-E; mogroside III; mogroside V; isomogroside V; 11-Oxomogroside; mogrol; 11-oxomogrol; 11-oxomogroside IA; 1-[13-hydroxykaur-16-en-18-oate] β-D-glucopyranuronic acid; 13-[(2-O-β-D-glucopyranosyl β-D-glucopyranosyl)oxy]-17-hydroxy-kaur-15-en-18-oic acid β-D-glucopyranosyl ester; 13-[(2-O-β-D-glucopyranosyl-β-D-glucopyranosyl)oxy] kaur-16-en-18-oic acid-(2-O-β-D-glucopyranosyl-β-D-glucopyranosyl)ester (rebaudioside E); 13-[(2-O-α-L-rhamnopyranosyl-3-O-β-D-glucopyranosyl-β-D-glucopyranosyl)oxy] kaur-16en-18-oic acid-(2-O-β-D-glucopyranosyl-β-D-glucopyranosyl) ester; 13-[(2-O-β-D-glucopyranosyl-3-O-β-D-glucopyranosyl-β-D-glucopyranosyl)oxy] kaur-16-en-18-oic acid-(2-O-α-L-rhamnopyranosyl-β-D-glucopyranosyl) ester; 13-[(2-O-β-D-glucopyranosyl β-D-glucopyranosyl)oxy]-17-oxo-kaur-15-en-oic acid β-D-glucopyranosyl ester; 13-[(2-O-(6-O-β-D-glucopyranosyl)-β-D-glucopyranosyl-β-D-glucopyranosyl)oxy] kaur-16-en-18-oic acid β-D-glucopyranosyl ester; 13-[(2-O-β-D-glucopyranosyl-3-O-β-D-fructofuranosyl-3-D-glucopyranosyl)oxy] kaur-16-en-18-oic acid β-D-glucopyranosyl ester; 13-[(2-O-β-D-glucopyranosyl-β-D-glucopyranosyl)oxy] kaur-16-en-18-oic acid-(6-O-β-D-xylopyranosyl-β-D-glucopyranosyl) ester; 13-[(2-O-β-D-glucopyranosyl-β-D-glucopyranosyl)oxy] kaur-16-en-18-oic acid-(4-O-(2-O-α-D-glucopyranosyl)-α-D-glucopyranosyl-D-glucopyranosyl) ester; 13-[(2-O-β-D-glucopyranosyl-3-O-β-D-glucopyranosyl-β-D-glucopyranosyl)oxy] kaur-16-en-18-oic acid-(2-O-6-deoxy-β-D-glucopyranosyl-β-D-glucopyranosyl) ester; 13-[(2-O-β-D-glucopyranosyl-β-D-glucopyranosyl)oxy] kaur-15-en-18-oic acid β-D-glucopyranosyl ester; 13-[(2-O-β-D-glucopyranosyl-3-O-β-D-xylopyranosyl-β-D-glucopyranosyl)oxy] kaur-16-en-18-oic acid β-D-glucopyranosyl ester; 13-[(2-O-β-D-xylopyranosyl-β-D-glucopyranosyl)oxy]kaur-16-en-18-oic acid β-D-glucopyranosyl ester; 13-[(3-O-β-D-glucopyranosyl-β-D-glucopyranosyl)oxy] kaur-16-en-18-oic acid β-D-glucopyranosyl ester; 13-[(2-O-6-deoxy-β-D-glucopyranosyl-3-O-β-D-glucopyranosyl-β-D-glucopyranosyl)oxy] kaur-16-en-18-oic acid β-D-glucopyranosyl ester; 13-[(2-O-6-deoxy β-D-glucopyranosyl-β-D-glucopyranosyl)oxy] kaur-16-en-18-oic acid β-D-glucopyranosyl ester; and mixtures thereof.

Additional exemplary sweetness enhancers include rebaudioside C, rebaudioside F, rebaudioside D, 13-[(2-O-β-D-glucopyranosyl-3-O-β-D-glucopyranosyl]-β-D-glucopyranosyl)oxy]-17-hydroxy-kaur-15-en-18-oic acid β-D-glucopyranosyl ester, 13-[(2-O-(3-O-β-D-glucopyranosyl)-β-D-glucopyranosyl-3-O-β-D-glucopyranosyl-β-D-glucopyranosyl)oxy] kaur-16-en-18-oic acid β-D-glucopyranosyl ester, and Rubusoside. Further for example, the at least one sweetness enhancer is chosen from rebaudioside A, stevioside, rebaudioside D, rebaudioside E, mogroside V, mogroside IV, brazzein, and monatin.

In some embodiments, the at least one sweetness enhancer is present in an amount at or below the sweetness detection threshold level of the at least one sweetness enhancer. In some embodiments, the at least one sweetness enhancer is present in an amount below the sweetness detection threshold level of the at least one sweetness enhancer. In some embodiments, the sweetness detection threshold level can be specific for a particular compound. Generally, in some embodiments, the sweetness enhancer is present in an amount ranging from 0.5 ppm to 1000 ppm. For example, in some embodiments, the sweetness enhancer is present in an amount ranging from 1 ppm to 300 ppm; or the sweetness enhancer is present in an amount ranging from 0.1 ppm to 75 ppm; or the sweetness enhancer is present in an amount ranging from 500 ppm to 3,000 ppm.

As used herein, the terms “sweetness threshold,” “sweetness recognition threshold,” and “sweetness detection threshold” are understood to mean the level at which the lowest known concentration of a certain sweet compound that is perceivable by the human sense of taste and it can vary from person to person. For example, a typical sweetness threshold level for sucrose in water can be 0.5% (by weight). Further for example, the at least one sweetness enhancer to be used can be assayed in water at least 25% lower and at least 25% higher than the sucrose detection level of 0.5% in water to determine the sweetness threshold level. A person of skill in the art will be able to select the concentration of the at least one sweetness enhancer so that it may impart an enhanced sweetness to a composition comprising at least one sweetener. For example, a skilled artisan may select a concentration for the at least one sweetness enhancer so that the at least one sweetness enhancer does not impart any perceptible sweetness to a composition that does not comprise at least one sweetener. In some embodiments, the compounds listed above as sweeteners may also function as sweetness enhancers. In some embodiments, some sweeteners may also function as sweetness enhancers and vice versa.

### Formulations

In one or more aspects, the disclosure provides formulations comprising the composition according to the foregoing aspects and embodiments. In these formulations, the composition can take any suitable form. In some embodiments, the polymethoxyflavone compositions are an amorphous solid, a crystal, a powder, a tablet, a liquid, a cube, a glace or coating, a granulated product, an encapsulated form around to or coated onto carriers or particles, wet or dried, or any combinations thereof.

For example, in one aspect, the polymethoxyflavone composition (according to any of the foregoing aspects or embodiments) can be provided in pre-portioned packets or in ready-to-use formulations.

In some embodiments, the formulations contain further additives known to those skilled in the art. These additives include, but are not limited to, bubble forming agents, bulking agents, carriers, fibers, sugar alcohols, oligosaccharides, sugars, high intensity sweeteners, nutritive sweeteners, flavorings, flavor enhancers, flavor stabilizers, acidulants, anti-caking and free-flow agents. Such additives are, for example, described by H. Mitchell (H. Mitchell, “Sweeteners and Sugar Alternatives in Food Technology”, Backwell Publishing Ltd, 2006), which is incorporated herein by reference in its entirety. As used herein, the term “flavorings” includes those flavors known to the skilled person, such as natural and artificial flavors. In some embodiments, these flavorings are synthetic flavor oils, flavoring aromatics or oils, oleoresins, and extracts derived from plants, leaves, flowers, fruits, and so forth, or combinations thereof. Non-limiting representative flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Useful flavorings include artificial, natural, and synthetic fruit flavors such as vanilla and citrus oils, including lemon, orange, lime, grapefruit, yuzu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with cooling agents.

In some embodiments, the flavorings provide breath freshening properties, particularly the mint flavors when used in combination with cooling agents. These flavorings may be used in liquid or solid form and may be used individually or in admixture. Other useful flavorings include aldehydes and esters such as cinnamyl acetate, cinnamaldehyde, citral diethylacetal, dihydrocarvyl acetate, eugenyl formate, p-methylamisol, and so forth may be used. Generally, any flavoring or food additives, such as those described in Chemicals Used in Food Processing (publication 1274, pages 63-258, by the National Academy of Sciences) may be used. This publication is incorporated herein by reference.

Further examples of aldehyde flavorings include, but are not limited to, acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, strawberry shortcake, and mixtures thereof. These listings of flavorings are merely exemplary and are not meant to limit either the term “flavoring” or the scope of the disclosure generally.

In some embodiments, the flavoring may be employed in either liquid form and/or dried form. When employed in the latter form, suitable drying means such as spray drying the oil may be used. Alternatively, the flavoring may be absorbed onto water soluble materials, such as cellulose, starch, sugar, maltodextrin, gum arabic and so forth or may be encapsulated. The actual techniques for preparing such dried forms are well-known.

In some embodiments, the flavorings may be used in many distinct physical forms well-known in the art to provide an initial burst of flavor and/or a prolonged sensation of flavor. Without being limited thereto, such physical forms include free forms, such as spray dried, powdered, beaded forms, encapsulated forms, and mixtures thereof.

In some embodiments, the present disclosure provides a consumable product comprising the composition according to several aspects presented herein. In some aspects, the consumable product comprises an effective amount of a composition comprising polymethoxyflavones.

In some embodiments, the effective amount of polymethoxyflavones in the formulation is from 0.5 to 20 ppm. Alternatively, in some embodiments, the effective amount is from 0.5 to 19 ppm. Alternatively, in some embodiments, the effective amount is from 0.5 to 18 ppm. Alternatively, in some embodiments, the effective amount is from 0.5 to 17 ppm. Alternatively, in some embodiments, the effective amount is from 0.5 to 16 ppm. Alternatively, in some embodiments, the effective amount is from 0.5 to 15 ppm. Alternatively, in some embodiments, the effective amount is from 0.5 to 14 ppm. Alternatively, in some embodiments, the effective amount is from 0.5 to 13 ppm. Alternatively, in some embodiments, the effective amount is from 0.5 to 12 ppm. Alternatively, in some embodiments, the effective amount is from 0.5 to 11 ppm. Alternatively, in some embodiments, the effective amount is from 0.5 to 10 ppm. Alternatively, in some embodiments, the effective amount is from 0.5 to 9 ppm. Alternatively, in some embodiments, the effective amount is from 0.5 to 8 ppm. Alternatively, in some embodiments, the effective amount is from 0.5 to 7 ppm. Alternatively, in some embodiments, the effective amount is from 0.5 to 6 ppm. Alternatively, in some embodiments, the effective amount is from 0.5 to 5 ppm. Alternatively, in some embodiments, the effective amount is from 0.5 to 4 ppm. Alternatively, in some embodiments, the effective amount is from 0.5 to 3 ppm. Alternatively, in some embodiments, the effective amount is from 0.5 to 2 ppm. Alternatively, in some embodiments, the effective amount is from 0.5 to 1 ppm.

Alternatively, in some embodiments, the effective amount is from 0.5 to 20 ppm. Alternatively, in some embodiments, the effective amount is from 1 to 20 ppm. Alternatively, in some embodiments, the effective amount is from 2 to 20 ppm. Alternatively, in some embodiments, the effective amount is from 3 to 20 ppm. Alternatively, in some embodiments, the effective amount is from 4 to 20 ppm. Alternatively, in some embodiments, the effective amount is from 5 to 20 ppm. Alternatively, in some embodiments, the effective amount is from 6 to 20 ppm. Alternatively, in some embodiments, the effective amount is from 7 to 20 ppm. Alternatively, in some embodiments, the effective amount is from 8 to 20 ppm. Alternatively, in some embodiments, the effective amount is from 9 to 20 ppm. Alternatively, in some embodiments, the effective amount is from 10 to 20 ppm. Alternatively, in some embodiments, the effective amount is from 11 to 20 ppm. Alternatively, in some embodiments, the effective amount is from 12 to 20 ppm. Alternatively, in some embodiments, the effective amount is from 13 to 20 ppm. Alternatively, in some embodiments, the effective amount is from 14 to 20 ppm. Alternatively, in some embodiments, the effective amount is from 15 to 20 ppm. Alternatively, in some embodiments, the effective amount is from 16 to 20 ppm. Alternatively, in some embodiments, the effective amount is from 17 to 20 ppm. Alternatively, in some embodiments, the effective amount is from 18 to 20 ppm. Alternatively, in some embodiments, the effective amount is from 19 to 20 ppm.

In some embodiments, the effective amount is 0.5 ppm, or 1 ppm, or 2 ppm, or 3 ppm, or 4 ppm, or 5 ppm, or 6 ppm, or 7 ppm, or 8 ppm, or 9 ppm, or 10 ppm, or 11 ppm, or 12 ppm, or 13 ppm, or 14 ppm, or 15 ppm, or 16 ppm, or 17 ppm, or 18 ppm, or 19 ppm, or 20 ppm.

The compositions, as well as the uses and methods (described below) can involve incorporating the polymethoxyflavonnes into consumable products. Suitable consumable products include, but are not limited to, beverages, dental products, cosmetic products, pharmaceutical products, and animal feed or animal food. For example, consumable products include all food products, including, but not limited to, cereal products, rice products, tapioca products, sago products, baker's products, biscuit products, pastry products, bread products, confectionary products, desert products, gums, chewing gums, chocolates, ices, honey products, treacle products, yeast products, baking-powder, salt and spice products, savory products, mustard products, vinegar products, sauces (condiments), tobacco products, cigars, cigarettes, processed foods, cooked fruits and vegetable products, meat and meat products, jellies, jams, fruit sauces, egg products, milk and dairy products, yoghurts, cheese products, butter and butter substitute products, milk substitute products, soy products, edible oils and fat products, medicaments, beverages, carbonated beverages, alcoholic drinks, beers, soft drinks, mineral and aerated waters and other non-alcoholic drinks, fruit drinks, fruit juices, coffee, artificial coffee, tea, cacoa, including forms requiring reconstitution, food extracts, plant extracts, meat extracts, condiments, sweeteners, nutraceuticals, gelatins, pharmaceutical and non-pharmaceutical gums, tablets, lozenges, drops, emulsions, elixirs, syrups and other preparations for making beverages, and combinations thereof. In some embodiments, the consumable product is a beverage product.

As used herein, the term “non-alcoholic drinks” includes, but is not limited to, all nonalcoholic drinks mentioned in the Directive 2003/115/EC of Dec. 22, 2003, and in the Directive 94/35/EC of Jun. 30, 2004, which are incorporated herein by reference, on sweeteners for use in foodstuffs. Examples include, but are not limited to, water-based, flavored drinks, energy-reduced or with no added sugar, milk- and milk-derivative-based or fruit-juice-based drinks, energy-reduced or with no added sugar, “Gaseosa”, nonalcoholic water-based drink with added carbon dioxide, sweeteners, and flavorings.

Consumable products include, without limitation, water-based consumables, solid dry consumables, dairy products, dairy-derived products and dairy-alternative products. In one aspect, the consumable product is a water-based consumable product including but not limited to beverage, water, aqueous beverage, enhanced/slightly sweetened water drink, flavored carbonated and still mineral and table water, carbonated beverage, non-carbonated beverage, carbonated water, still water, soft drink, non-alcoholic drink, alcoholic drink, beer, wine, liquor, fruit drink, juice, fruit juice, vegetable juice, broth drink, coffee, tea, black tea, green tea, oolong tea, herbal infusion, cacao (e.g. water-based), tea-based drink, coffee-based drinks, cacao-based drink, infusion, syrup, frozen fruit, frozen fruit juice, water-based ice, fruit ice, sorbet, dressing, salad dressing, jams, marmalades, canned fruit, savoury, delicatessen products like delicatessen salads, sauces, ketchup, mustard, pickles and marinated fish, sauce, soup, and beverage botanical materials (e.g. whole or ground), or instant powder for reconstitution (e.g. coffee beans, ground coffee, instant coffee, cacao beans, cacao powder, instant cacao, tea leaves, instant tea powder). In another embodiment, the consumable product is a solid dry consumable product including but not limited to cereals, baked food products, biscuits, bread, breakfast cereal, cereal bar, energy bars/nutritional bars, granola, cakes, rice cakes, cookies, crackers, donuts, muffins, pastries, confectionaries, chewing gum, chocolate products, chocolate, fondant, hard candy, marshmallow, pressed tablets, snack foods, botanical materials (whole or ground), and instant powders for reconstitution.

Non-limiting examples of consumable products are disclosed in PCT Publication No. WO 2012/107203.

### Uses and Methods

In one or more aspects, the disclosure provides uses of polymethoxyflavones to modify a flavor of a consumable product. In some embodiments, modifying the flavor comprises enhancing a mouthfeel, reducing bitterness, or a combination thereof. In some embodiments, the polymethoxyflavones are present in the consumable product at a concentration ranging from 0.5 ppm to 50 ppm, or from 0.5 ppm to 20 ppm, or from 1 ppm to 5 ppm. In some embodiments, the polymethoxyflavones are: sinensetin, heptamethoxyflavone, nobiletin, tetra-O-methylscutellarein, hexamethoxyquercetogetin, tangeretin, or any combination thereof. In some embodiments, the consumable product comprises a sweetener, such as a low-caloric sweetener. In some embodiments, the consumable product is a beverage product, such as a low-caloric beverage, a greened juice, or a bitter beverage (e.g., tea or coffee).

In one or more aspects, the disclosure provides a method of modifying a flavor of a consumable product, the method comprising: introducing polymethoxyflavones to a consumable product. In some embodiments, the method of modifying the flavor of a consumable product comprises enhancing a mouthfeel of a consumable product, reducing bitterness of a consumable product, or a combination thereof. In some embodiments, the polymethoxyflavones are present in the consumable product at a concentration ranging from 0.5 ppm to 50 ppm, or from 0.5 ppm to 20 ppm, or from 1 ppm to 5 ppm. In some embodiments, the polymethoxyflavones are: sinensetin, heptamethoxyflavone, nobiletin, tetra-O-methylscutellarein, hexamethoxyquercetogetin, tangeretin, or any combination thereof. In some embodiments, the consumable product comprises a sweetener, such as a low-caloric sweetener. In some embodiments, the consumable product is a beverage product, such as a low-caloric beverage, a greened juice, or a bitter beverage (e.g., tea or coffee).

In some embodiments of the foregoing uses and methods, the polymethoxyflavones are used to convey, enhance, or improve the mouthfeel of a consumable product.

In some embodiments of the foregoing uses and methods, the polymethoxyflavones are used to reduce the bitterness of a consumable product.

In some embodiments, the present disclosure provides a method to convey, enhance, or improve the perception of mouthfeel of a consumable product in a subject in need thereof, wherein the method comprises contacting the subject with the composition according to several aspects presented herein in an amount effective to convey, enhance, or improve the subject's perception of mouthfeel.

In some embodiments, the present disclosure provides a method to reduce the perception of bitterness of a consumable product in a subject in need thereof, wherein the method comprises contacting the subject with the composition according to several aspects presented herein in an amount effective to reduce the subject's perception of sweetness.

In some embodiments of any of the foregoing aspects and embodiments of this section, the effective amount of polymethoxyflavones in the consumable product is from 0.5 to 20 ppm. Alternatively, in some embodiments, the effective amount is from 0.5 to 19 ppm. Alternatively, in some embodiments, the effective amount is from 0.5 to 18 ppm. Alternatively, in some embodiments, the effective amount is from 0.5 to 17 ppm. Alternatively, in some embodiments, the effective amount is from 0.5 to 16 ppm. Alternatively, in some embodiments, the effective amount is from 0.5 to 15 ppm. Alternatively, in some embodiments, the effective amount is from 0.5 to 14 ppm. Alternatively, in some embodiments, the effective amount is from 0.5 to 13 ppm. Alternatively, in some embodiments, the effective amount is from 0.5 to 12 ppm. Alternatively, in some embodiments, the effective amount is from 0.5 to 11 ppm. Alternatively, in some embodiments, the effective amount is from 0.5 to 10 ppm. Alternatively, in some embodiments, the effective amount is from 0.5 to 9 ppm. Alternatively, in some embodiments, the effective amount is from 0.5 to 8 ppm. Alternatively, in some embodiments, the effective amount is from 0.5 to 7 ppm. Alternatively, in some embodiments, the effective amount is from 0.5 to 6 ppm. Alternatively, in some embodiments, the effective amount is from 0.5 to 5 ppm. Alternatively, in some embodiments, the effective amount is from 0.5 to 4 ppm. Alternatively, in some embodiments, the effective amount is from 0.5 to 3 ppm. Alternatively, in some embodiments, the effective amount is from 0.5 to 2 ppm. Alternatively, in some embodiments, the effective amount is from 0.5 to 1 ppm.

Alternatively, in some embodiments, the effective amount is from 0.5 to 20 ppm. Alternatively, in some embodiments, the effective amount is from 1 to 20 ppm. Alternatively, in some embodiments, the effective amount is from 2 to 20 ppm. Alternatively, in some embodiments, the effective amount is from 3 to 20 ppm. Alternatively, in some embodiments, the effective amount is from 4 to 20 ppm. Alternatively, in some embodiments, the effective amount is from 5 to 20 ppm. Alternatively, in some embodiments, the effective amount is from 6 to 20 ppm. Alternatively, in some embodiments, the effective amount is from 7 to 20 ppm. Alternatively, in some embodiments, the effective amount is from 8 to 20 ppm. Alternatively, in some embodiments, the effective amount is from 9 to 20 ppm. Alternatively, in some embodiments, the effective amount is from 10 to 20 ppm. Alternatively, in some embodiments, the effective amount is from 11 to 20 ppm. Alternatively, in some embodiments, the effective amount is from 12 to 20 ppm. Alternatively, in some embodiments, the effective amount is from 13 to 20 ppm. Alternatively, in some embodiments, the effective amount is from 14 to 20 ppm. Alternatively, in some embodiments, the effective amount is from 15 to 20 ppm. Alternatively, in some embodiments, the effective amount is from 16 to 20 ppm. Alternatively, in some embodiments, the effective amount is from 17 to 20 ppm. Alternatively, in some embodiments, the effective amount is from 18 to 20 ppm. Alternatively, in some embodiments, the effective amount is from 19 to 20 ppm.

In some embodiments, the effective amount is 0.5, or 1, or 2, or 3, or 4, or 5, or 6, or 7, or 8, or 9, or 10, or 11, or 12, or 13, or 14, or 15, or 16, or 17, or 18, or 19, or 20 ppm.

The present invention is best illustrated but is not limited to the following examples.

### EXAMPLES

### Example 1: The Effect of a Composition Comprising Polymethoxyflavones on the Perception of Mouthfeel in a Reduced High Fructose Corn Syrup Lemon-Lime Carbonated Beverage

A composition comprising polymethoxyflavones was added to a lemon-lime flavored carbonated beverage containing a 50% reduced level of high fructose corn syrup. The final concentration of the composition comprising polymethoxyflavones was 2 ppm.

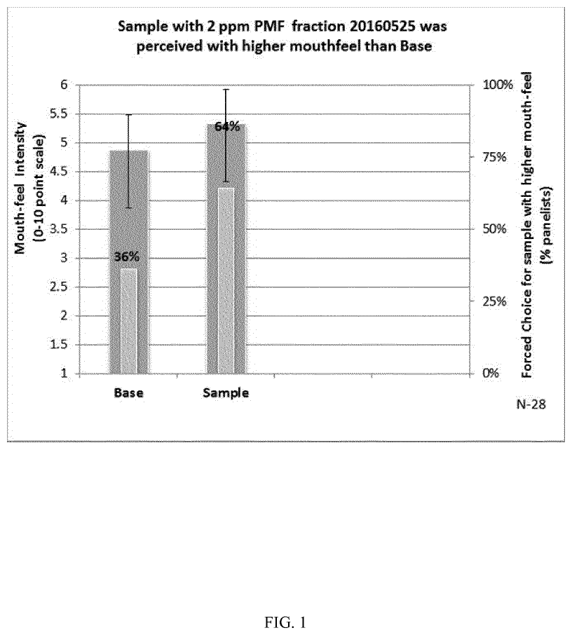

Sensory Evaluations: A sensory panel consisted of 28 trained panelists. The panelists were asked to evaluate the mouthfeel intensity perceived of a test and control lemon-lime flavored carbonated beverage containing a 50% reduced level of high fructose corn syrup. The results are shown in FIG. 1. The addition of 2 ppm polymethoxyflavones to a lemon-lime flavored carbonated beverage containing a 50% reduced level of high fructose corn syrup resulted in a significantly higher mouthfeel perception, compared to a control beverage.

In a separate experiment, a composition comprising polymethoxyflavones was added to a greened orange juice, at a final concentration of 3 ppm. The addition of 3 ppm polymethoxyflavones to the greened orange juice resulted in a significant reduction in perceived bitterness, compared to a control beverage.

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

1-15. (canceled)

16. A method of enhancing mouthfeel of a consumable product, the method comprising introducing one or more polymethoxyflavones to a flavored product in an amount effective to enhance the mouthfeel thereof.

17. The method of claim 16, wherein the one or more polymethoxyflavones are present in the consumable product at a concentration ranging from 0.5 ppm to 50 ppm.

18. The method of claim 16, wherein the one or more polymethoxyflavones are selected from the group consisting of: sinensetin, heptamethoxyflavone, nobiletin, tetra-O-methylscutellarein, hexamethoxyquercetogetin, tangeretin, and any combinations thereof.

19. The method of claim 16, wherein the consumable product comprises a sweetener.

20. The method of claim 19, wherein the sweetener comprises sucrose, fructose, or any combination thereof.

21. The method of claim 19, wherein the sweetener comprises a steviol glycoside, a mogroside, a sugar alcohol, aspartame, acesulfame K, sucralose, or any combination thereof.

22. The method of claim 19, wherein the consumable product further comprises a sweetness enhancer.

23. The method of claim 22, wherein the sweetness enhancer comprises a terpene or a derivative thereof, a flavonoid or a derivative thereof, a flavanone or a derivative thereof, or any combinations of the foregoing.

24. The method of claim 16, wherein the consumable product is a beverage.

25. A method of reducing a bitter taste of a consumable product, the method comprising introducing one or more polymethoxyflavones to a flavored product in an amount effective to enhance the bitter taste thereof.

26. The method of claim 25, wherein the one or more polymethoxyflavones are present in the consumable product at a concentration ranging from 0.5 ppm to 50 ppm.

27. The method of claim 25, wherein the one or more polymethoxyflavones are selected from the group consisting of: sinensetin, heptamethoxyflavone, nobiletin, tetra-O-methylscutellarein, hexamethoxyquercetogetin, tangeretin, and any combinations thereof.

28. The method of claim 25, wherein the consumable product comprises a sweetener.

29. The method of claim 28, wherein the sweetener comprises sucrose, fructose, or any combination thereof.

30. The method of claim 28, wherein the sweetener comprises a steviol glycoside, a mogroside, a sugar alcohol, aspartame, acesulfame K, sucralose, or any combination thereof.

31. The method of claim 28, wherein the consumable product further comprises a sweetness enhancer.

32. The method of claim 31, wherein the sweetness enhancer comprises a terpene or a derivative thereof, a flavonoid or a derivative thereof, a flavanone or a derivative thereof, or any combinations of the foregoing.

33. The method of claim 25, wherein the consumable product is a beverage.
